(19) United States
(12) Patent Application Publication
(10) Pub. No.: US 2008/0120364 A1
(43) Pub. Date: May 22, 2008

(54) Content insertion in a mesh network

(76) Inventors: Amalavoyal Chari, Sunnyvale, CA (US); Devabhaktuni Srikrishna, Sunnyvale, CA (US); Prashanth Aravinda-Kumar, Goleta, CA (US)

Correspondence Address: Tropos Networks, PO Box 641867, San Jose, CA, 95164-1867, US

(21) Appl. No.: 11/602,422

(22) Filed: Nov. 20, 2006

(51) Int. Cl. G06F 15/16

(52) U.S. Cl. 709/203

(57) ABSTRACT

Embodiments of methods and systems for inserting customized content into web pages viewed by users of client devices are disclosed. The method includes the wireless mesh node providing wireless access to a client device to create a connection to a wired server, and the mesh node inserting customized content into a traffic stream between the client device and the wired server, wherein the customized content is content that is tailored to an end user of the client device.

### FIELD OF THE INVENTION

The present invention generally relates to wireless communications. More specifically, the present invention relates to a system and method for inserting customized content into a data stream of a client device that is wirelessly connected to a mesh network.

### BACKGROUND OF THE INVENTION

Mobile client devices, such as, laptops, personal digital assistants (PDAs), and hand-held devices are able to obtain wireless Internet access at wireless access points. One form of wireless access points are WiFi access points that are compatible with IEEE 802.11, as certified by the Wireless Fidelity (WiFi) Alliance.

The internet has become an effective mode of advertising in which advertising is focused on characteristics of the user. Mobile client devices provide a unique user that can be uniquely targeted for advertising. For example, mobile client devices typically roam from one access point to another. Therefore, the location of the mobile client device as determined, for example, by the locations of the access points, can be a valuable piece of information in targeted advertising.

Wireless mesh networks are rapidly gaining popularity as a method for allowing client devices to access the internet due to an ease of deploying the networks as compared to wired access points. Wireless mesh networks provide many wireless access points that mobile client devices can use to access the internet. Therefore, wireless mesh networks have the capability to provide even more client information that can be valuable for targeted advertising.

It is desirable to have a system and apparatus for providing customized, targeted advertising to users of client devices that access the Internet through wireless mesh networks.

### SUMMARY OF THE INVENTION

A first embodiment includes method of a wireless mesh node providing content insertion. The method includes the wireless mesh node providing wireless access to a client device to create a connection to a wired server, and the mesh node inserting customized content into a traffic stream between the client device and the wired server, wherein the customized content is content that is tailored to an end user of the client device.

A second embodiment includes a method of a wireless mesh network providing content insertion. The method includes a first access node providing wireless access to a client device to create a connection to a wired server. The first access node proxies a TCP session between the client device and the wired server, enabling the insertion of customized content to be transparent to the client device and the wired server. The first access node inserts customized content into a traffic stream between the client device and the wired server, wherein the customized content is content that is tailored to an end user of the client device. The client device can roam from the first access node to the second access node. The second access node queries a plurality of other access nodes including the first access node, and the first access node responds to the query of the second access node with session identifiers for sessions from the client device being proxied through the first access node

A third embodiment includes a method of a wireless mesh node providing advertising. The method includes the mesh node providing a wireless connection between a client device and a wired server. The mesh node routes data traffic between the client device and the wired server. The mesh node detects predetermined characteristics of a TCP stream within the data traffic, and inserts customized content into the TCP stream between the client device and the at least one wired server when the predetermined characteristic are detected.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an example of a wireless mesh network that includes access nodes that methods of inserting customized content into web pages are operable;

FIG. 2A is a flow chart that includes steps of an example of a method of inserting customized content into web pages;

FIG. 2B is a flow chart that includes steps of another example of a method of inserting customized content into web pages;

FIG. 2C is a flow chart that includes steps of another example of a method of inserting customized content into web pages;

FIG. 3 is a block diagram that shows how embodiments of the methods of inserting customized content are structured; and

### DETAILED DESCRIPTION OF THE INVENTION

Embodiments of methods and systems for inserting customized content into web pages viewed by users of client devices are disclosed. The content is customized in that the content is tailored to end users of the client devices. The content can be, for example, tailored to a location of the end users, or related to content requested by the end user. One embodiment provides for client device roaming while maintaining the insertion of customized content.

Presently, servers in wired networks that provide content insertion tend to be centralized and not capable of adapting to client device mobility events. However, in a wireless mesh network, a high degree of client device mobility is to be expected. Embodiments of distributed content-insertion architectures are described that include mesh nodes of a wireless mesh network performing content insertion. For these embodiments, it is important to provide for client device mobility and to ensure that application session-persistence is maintained as client devices roam from one access node to another. An advantage of the distributed architecture is that it is highly scalable, since the processing related to content-insertion is distributed over a large number of access nodes (potentially thousands in a single network). Another advantage of the distributed architecture is that a service provider does not need to deploy a dedicated content-insertion server into their core network, thereby enabling cost-savings. Another advantage of the distributed architecture is that it is fault-tolerant (like the mesh network itself) and has no single point of failure.

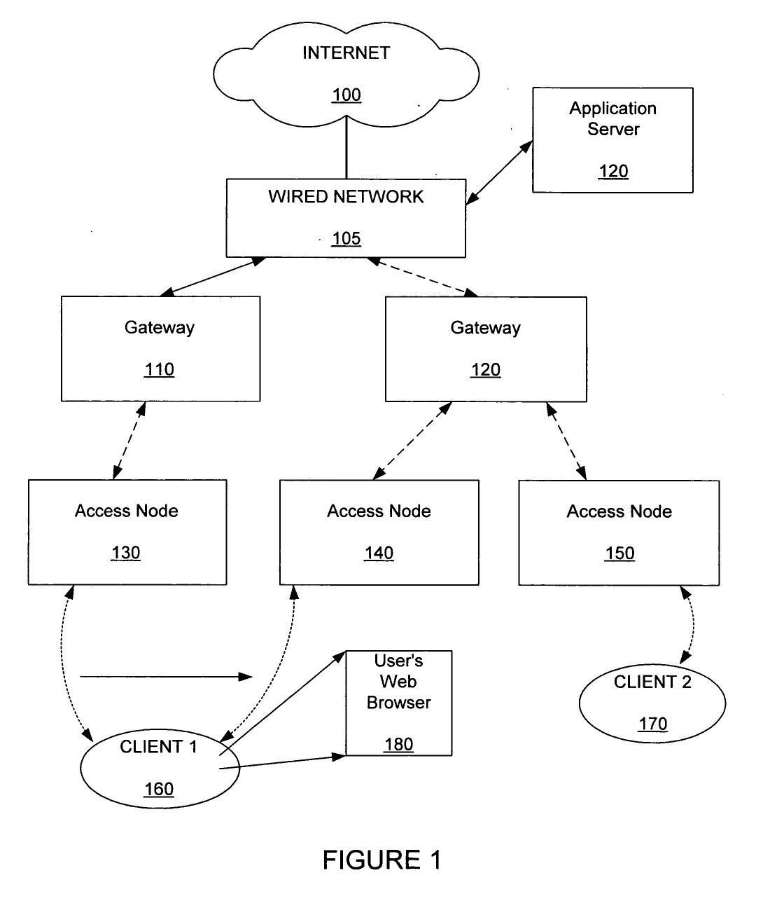

FIG. 1 shows an example of a wireless mesh network in which embodiments of the methods of providing insertion of customized content can be operated. Generally, the methods are operable on access nodes 130, 140, 150 (servers) of the wireless mesh network. Each access node 130, 140, 150 can include the customized content insertion methods, and therefore, the processing of the methods is de-centralized. More specifically, the methods do not require a centralized server, but are operable on distributed servers, such as provide by embodiments of wireless mesh networks. While the methods are described as operable on an access node, it should be understood that an access node can be a gateway. Therefore, the methods are operable on gateways of wireless networks as well.

The wireless mesh network includes gateways 110, 120 that can be wired or wirelessly connected to a wired network 105. The wired network 105 can be connected, for example, to the Internet 100. The access nodes 130, 140, 150 provide client devices 160, 170 with wireless access to the Internet. While a user of a client device (such as client device 160) accesses the Internet, an application server 120 (such as a web server) can provide content to the end-user. For example, the http protocol enables a web browser on a client device to request content from a web server. In response to an http GET request from the client device directed at a URL (Uniform Resource Locator) on the web server, the web server returns to the client device a file that can be opened by the web browser application on the client device. The access node 130 can insert customized content into this traffic stream between the server 120 and the client device 160. Generally, the content is inserted by detecting, for example, predetermined characteristics of the traffic stream, and then inserting the customized content into the TCP stream. Exemplary predetermined characteristics include an application type, a TCP port number and/or a TCP packet type. The content can be customized in that the content is tailored to the user of the client device. More specifically, the content can be tailored to a location of the client device, or related to content requested by the user of the client device. For the wireless mesh networks described, the location of the access node the client device is associated to can be used as a first order approximation of the location of the client device.

In order for a client device to seamlessly roam from one access node to another access node without resetting or terminating existing sessions, an embodiment includes the access node (such as access node 130) proxying a TCP session between the client device (such as client device 160) and the wired server (such as, server 120). When the client device 160 roams to another access node (such as, access node 140), the access node 140 queries other access nodes of the mesh network for information related to the client device and its currently active sessions that are being proxied through other access nodes in the mesh network. The access node 130 responds to the query of the access node 140 with session identifiers for those active sessions from the client device 160 that were being proxied through the access node 130. A session identifier can include information about the client's IP address, the IP address of the other end-point of the session and the source and destination port numbers. The access node 140 thereafter directs traffic corresponding to the session identifiers returned by access node 130 through access node 130. As a result, the insertion of customized content is transparent to the client device 160 and the wired server 120. Any new sessions initiated by the client device 160 after it has roamed to access node 140 are directly proxied by access node 140 whereas pre-existing sessions (such as those that were being proxied through access node 130) continue to be directed through access node 130, which proxies them.

After the client device 160 has roamed to the access node 140, the access node 140 sets up routing rules to forward traffic for the sessions to the access node 130 for proxying while acting as a proxy for all other session traffic from the client device 160. The routing rules can be set up by using session-based routing using primitives such as iptables of the Linux operating system.

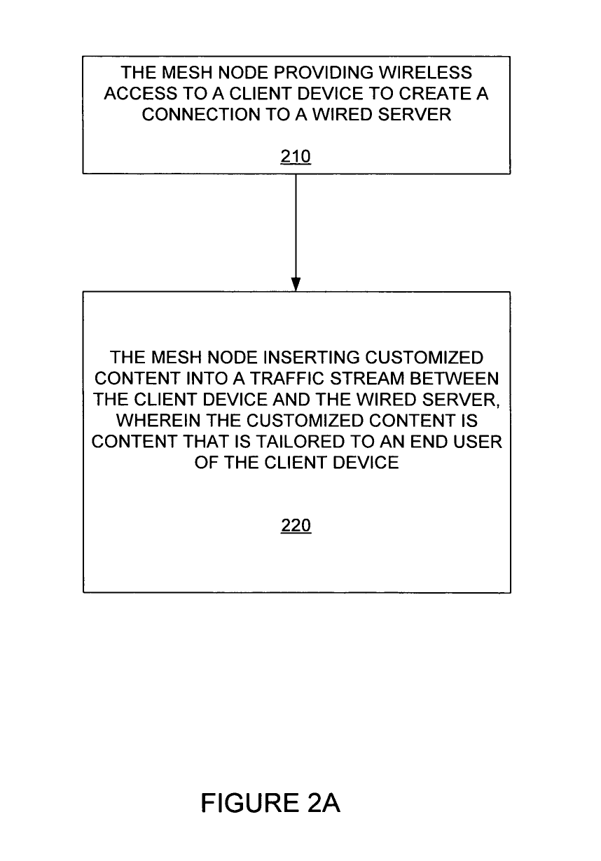

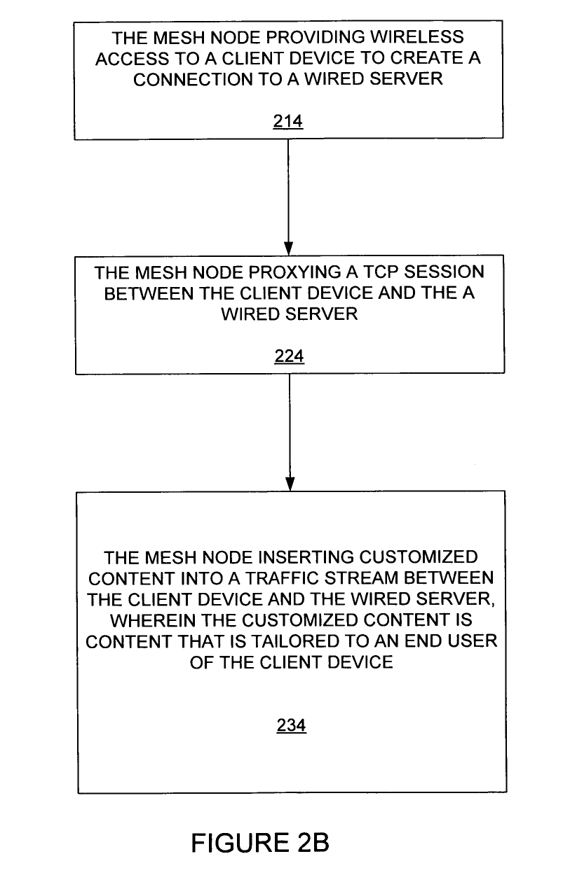

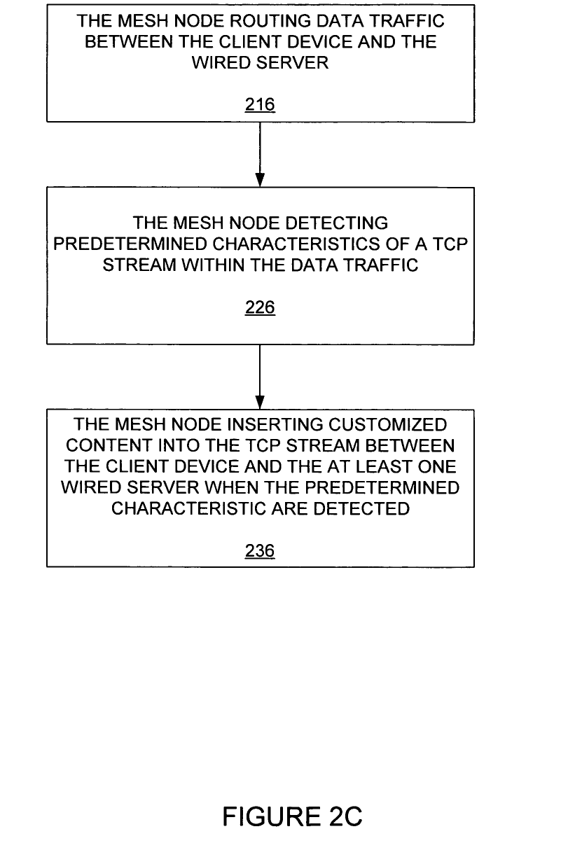

FIG. 2A is a flow chart that includes steps of an example of a method of inserting customized content into web pages. A first step 210 includes the mesh node providing wireless access to a client device to create a connection to a wired server. A second step 220 includes the mesh node inserting customized content into a traffic stream between the client device and the wired server, wherein the customized content is content that is tailored to an end user of the client device. Content insertion can be made to occur bi-directionally. Content insertion in the upstream direction (towards a gateway) can be used to provide the application server with information about the client device, such as the device's location. Content insertion in the downstream direction (to the client device) can be used to deliver targeted content, such as targeted advertising, to the end-user. Additionally, information about the client device can allow the server to deliver more targeted search results. Information about the client device can also include the device type. Different kinds of mobile devices include music players, gaming consoles, PDAs, voice handsets, etc.

FIG. 2B is a flow chart that includes steps of another example of a method of inserting customized content into web pages. A first step 214 includes the mesh node providing wireless access to a client device to create a connection to a wired server. A second step 224 includes the mesh node proxying a TCP session between the client device and the wired server; wherein the insertion of customized content is transparent to the client device and the wired server. A third step 230 includes the mesh node inserting customized content into a traffic stream between the client device and the wired server, wherein the customized content is content that is tailored to an end user of the client device.

When the client device roams from the first access node to the second access node, the second access node queries other access nodes including the first access node. The first access node responds to the query of the second access node with session identifiers for sessions from the client device being proxied through the first access node. The second access node can set up routing rules to forward traffic for the sessions to the first access node for proxying while acting as a proxy for all other session traffic from the client device. As previously described, the routing rules can be set up by using session-based routing using primitives such as iptables of the Linux operating system.

HTTP responses generally have a “content-length” header. A standard compliant browser only displays specific bytes of the web page.

FIG. 2C is a flow chart that includes steps of another example of a method of inserting customized content into web pages. A first step 216 includes the mesh node routing data traffic between the client device and the wired server. A second step 226 includes the mesh node detecting predetermined characteristics of a TCP stream within the data traffic. A third step 236 includes the mesh node inserting customized content into the TCP stream between the client device and the at least one wired server when the predetermined characteristic are detected. The predetermined characteristic can be, for example, an application type, a TCP port number, a TCP packet type.

Classifications of client devices can be maintained. For example, on classification of a client device is whether the user of the client device is a paying or non-paying user. If the user is a non-paying user, the customized content can be inserted, whereas the customized content may not be inserted for client device of a paying user.

The customized content can be any content that relates to the user of the client device. Location has been mentioned as a customized content, but customized content can also include user information. The customized content can be advertising, or any other useful information such as public announcements, or even search results relevant to the client device or the end user.

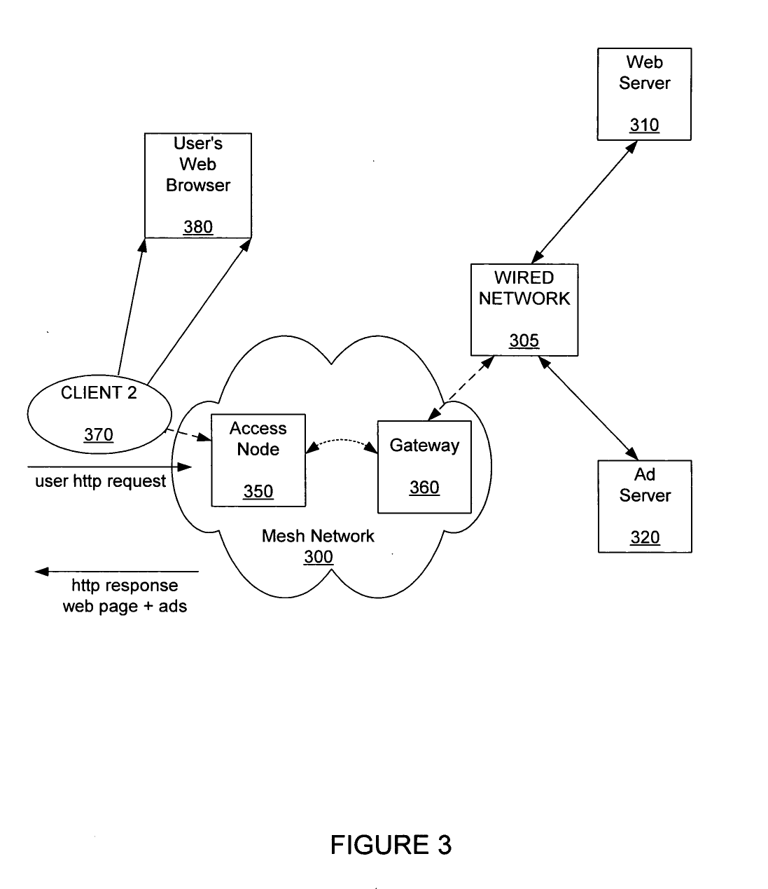

FIG. 3 is a block diagram that shows how embodiments of the methods of inserting customized content are structured. As shown, a mesh network 300 that includes a gateway 360 and an access node 350 provides a client device 370 with access to a wired network 305. A web server 310 and an ad server 320 can be connected to the wired network 305. The ad server depicted 320 is an example of a server that provides customized content that can be inserted into the traffic stream by access nodes (such as access node 350) of the mesh network 300. In one embodiment, the access nodes insert identifying characteristics of the end-user (such as the user's location) into the traffic stream so that the ad server can deliver targeted advertising. Google's® ADSENSE service is an example of an ad-serving network that can target ads based on multiple criteria including the content of the web page requested by the client. The customized content appears on the client device's web browser 380.

The http protocol enables the web browser 380 on the client device 370 to request content from a web server (such as ad server 320). In response to an http GET request from the client 370 directed at a URL (Uniform Resource Locator) on the ad server 320, the ad server 320 returns to the client device 370 a file that can be opened by the web browser 380 on the client device 370. The access node 350 can insert customized content into this traffic stream between the ad server 320 and the client device 370. Generally, the content is inserted by detecting, for example, predetermined characteristics of the traffic stream, and then inserting the customized content into the TCP stream.

The access nodes can gather client data. For example, the access nodes may determine the approximate location of the client device by a variety of means. This location information can be embedded in the traffic stream, thereby enabling the ad-serving network to deliver ads that showcase local businesses near that location. In another example, the data gathered may relate to search terms searched for by the end-user. For instance, if the user has recently performed searches on Google® for “cars”, then a car advertisement might be appropriate to show the user and the user would be more likely to click on the ad and choose to learn more. In another example, the data gathered may relate to the user's browsing history. A user who frequents job-listing site might be interested in ads that relate to jobs available in the area.

A large amount of data regarding the end-user can be gathered by the access nodes by passively monitoring end-user traffic. This can be done with the explicit permission of the user, so as not to violate privacy. Other privacy safeguards might include omitting personally identifiable information about the user from the query to the ad-serving network and ensuring that local log files containing users' browsing history be periodically deleted. Service providers may choose to enable these advertising services for some subsets of their user base and implement and document a variety of privacy policies as part of their “Terms of Use” agreements with their subscribers.

The method of customized content insertion can provide non-intrusive insertion of ads into web pages viewed by the users of client devices wirelessly connected to access nodes of the wireless mesh network. The insertion can be triggered to insert content for classes of client device users. For example, there can be paying and non-paying users. The service provider operating the network might decide to target ads at non-paying users while ensuring that paying or premium users enjoy an ad-free experience.

It is possible for mesh access nodes to fail due to a variety of reasons. For example, a mesh access node may lose access to power due to a power blackout, and may, therefore, be no longer capable of providing access to client devices. In such an event, it is desirable for the mesh system to fail-over so as to continue providing access (through those mesh access nodes that are still working) as well as continue to provide content insertion services.

The problem of continuing to provide access in the case of failures can be addressed through mesh routing and handoff algorithms. In order to continue to provide content insertion services in case of failures of access nodes, the session identifiers for client sessions in progress need to be redundantly maintained across multiple access nodes. Each access node can share client session identifier information with other access nodes. In one embodiment, this function is executed periodically. As a result, multiple access nodes have possession of the session identifiers for each client device, such that even if one access node fails, one of the other access nodes are able to provide this session identifier information, upon being queried.

In one embodiment, upon a client device roaming event, the new access node can query other access nodes to obtain session identifiers for sessions to/from the client device that are in progress. If the old access node has failed, another access node that has possession of the session identifier information can respond to the query with the session identifier information. The new access node can then verify if each old access node through which sessions were being proxied is still alive or whether it has failed. In the event that the new access node determines that an old access node is still functioning, it can direct traffic from those sessions to the old access node which can then proxy those sessions to the destination server as described previously. However, in the event that the new access node determines that one of the old access nodes that were proxying client sessions has failed, the new access node can send a TCP reset packet to the client device on behalf of the other session end-point (the destination server). This causes the client device to initiate a new session, without loss of IP-layer connectivity. Otherwise, directing traffic to a node that has failed could eventually result in client timeouts that can be disruptive to the end-user experience.

In one embodiment, if an access node that a client device is currently connecting through fails, the client device reconnects through a different access node. This amounts to a client roaming event as previously described.

It is understood that the examples and embodiments described herein are for illustrative purposes only and that various modifications or changes in light thereof will be suggested to persons skilled in the art and are to be included within the spirit and purview of this application and scope of the appended claims. Accordingly, the disclosures and descriptions herein are intended to be illustrative, but not limiting, of the scope of the invention which is set forth in the following claims.

What is claimed is:

1. A method of a wireless mesh node providing content insertion, comprising:
the mesh node providing wireless access to a client device to create a connection to a wired server,
the mesh node inserting customized content into a traffic stream between the client device and the wired server, wherein
the customized content is content that is tailored to an end user of the client device.

2. The method of claim 1, wherein the customized content is tailored to location of the client device.

3. The method of claim 1, wherein the customized content is related to content requested by the end user.

4. The method of claim 1, wherein the customized content comprises advertising.

5. The method of claim 1, further comprising:
the mesh node proxying a TCP session between the client device and the wired server; wherein the insertion of customized content is transparent to the client device and the wired server.

6. The method of claim 5 further comprising the mesh node sharing session identifiers for sessions that it is proxying with at least one other mesh access node.

7. The method of claim 1, wherein the customized content is customized based on at least one of a client location, a URL requested by the client device, and terms searched for by the client device.

8. The method of claim 1, wherein the customized content is only inserted if the client device is within a predetermined classification.

9. The method of claim 8, wherein the predetermined classification is a non-paying subscriber.

10. A method of a wireless mesh network providing content insertion, the mesh network comprising a first access node and a second access node, the method comprising:
the first node proxying a TCP session between client device and the at least one wired server;
the mesh node inserting customized content into a traffic stream between the client device and at least one wired server.

11. The method of claim 10, wherein the first access node shares session identifiers for sessions that it is proxying with at least a third node.

12. The method of claim 10, further comprising:
the client device roaming from the first access node to the second access node;
the second access node querying a plurality of other access nodes including the first access node;
the first access node responding to the query of the second access node with session identifiers for sessions from the client device being proxied through the first access node.

13. The method of claim 11, further comprising:
the client device roaming from the first access node to the second access node;
the second access node querying a plurality of other access nodes including the first access node;
the third access node responding to the query of the second access node with session identifiers for sessions from the client device being proxied through the first access node

14. The method of claim 13, further comprising:
the second access node determining whether the first access node is alive, and if the first access node is not alive, sending a TCP reset to the client device on behalf of the other TCP end-point for sessions that were being proxied through the first access node to force the client device to re-initiate any sessions that were being proxied through the first access node.

15. The method of claim 10, further comprising:
the second access node setting up routing rules to forward traffic for the sessions to the first access node for proxying while acting as a proxy for all other session traffic from the client device.

16. A method of a wireless mesh node providing advertising, the mesh node providing a wireless connection between a client device and a wired server, comprising:
the mesh node routing data traffic between the client device and the wired server;
the mesh node detecting predetermined characteristics of a TCP stream within the data traffic;
the mesh node inserting customized content into the TCP stream between the client device and the at least one wired server when the predetermined characteristic are detected.

17. The method of claim 16, wherein the predetermined characteristic comprises at least one of an application type, a TCP port number, a TCP packet type.

18. A method of operating a wireless mesh network, comprising:
each node within the wireless mesh network gathering client data;
based on the gathered client data, directing customized content to end users by inserting the customized content into data streams.

19. The method of claim 18, wherein the client data comprises at least one of a client device location, a URL requested by the client device, terms searched for by the client device.

20. A method of operating a wireless mesh network, comprising:
each node within the wireless mesh network gathering client device data;
the node conveying the gathered client data device to an internet server;
receiving content from the internet server that is customized based on the gathered data.

21. A method of a wireless mesh node providing content insertion, comprising:
the mesh node providing wireless access to a client device to create a connection to a wired server, the mesh node inserting customized content into a traffic stream between the client device and the wired server, wherein
the customized content is tailored to location of the client device.

22. A method of a wireless mesh node providing content insertion, comprising:
the mesh node providing wireless access to a client device to create a connection to a wired server,
the mesh node inserting customized content into a traffic stream between the client device and the wired server, wherein
the customized content is related content requested by the end user.
